(19) United States
(12) Patent Application Publication
(10) Pub. No.: US 2026/0356324 A1
(43) Pub. Date: Nov. 12, 2026

(54) DETERMINING A POSITION OF A VEHICLE KEY

(71) Applicant: Continental Automotive Technologies GmbH, Hannover (DE)

(72) Inventors: Stefan Kerscher, Mengkofen (DE); Sébastien Chanal, Colomiers (FR)

(21) Appl. No.: 19/134,337

(22) PCT Filed: Nov. 2, 2023
(86) PCT No.: PCT/DE2023/200220

§ 371 Date: May 30, 2025

(30) Foreign Application Priority Data
Dec. 1, 2022 (DE) 10 2022 212 921.0

(51) Int. Cl. B60R 25/24; B60R 25/31

(52) U.S. Cl. CPC B60R 25/245; B60R 25/31

(57) ABSTRACT

A method and an apparatus for determining a position of a vehicle key relative to a vehicle, wherein there is provision for multiple transceivers on the vehicle for determining a respective vehicle key distance between the respective transceiver and the vehicle key. Multiple comparison points are defined in space and the apparatus is designed such that, for each comparison point, the comparison point distances of the comparison point from transceivers that were able to determine a vehicle key distance from the vehicle key are added as a comparison point distance sum. Two quadrants for whose respective comparison point the smallest comparison point distance sums were determined are defined as selected quadrants. The vehicle key position, from possible vehicle key positions in selected quadrants, for which the shortest vehicle key distance was identified by a transceiver is assumed to be the actual vehicle key position.

### CROSS-REFERENCE TO RELATED APPLICATIONS

This application is a national stage application, filed under 35 U.S.C. § 371, of International Patent Application No. PCT/DE2023/200220, filed on Nov. 2, 2023, which is incorporated by reference herein in its entirety.

### TECHNICAL FIELD

The technical field relates to a method and an apparatus for determining a position of a vehicle key, in particular for a motor vehicle having a motor vehicle entry system.

### BRIEF DESCRIPTION OF THE DRAWINGS

Further features and advantages of some advantageous configurations of the disclosure will emerge from the description below of exemplary embodiments with reference to the drawings, in which, to illustrate some possible configurations of the disclosure, in each case in simplified schematic form, by way of example,

FIG. 1 shows, in schematically simplified form, a vehicle having multiple transceivers for determining a position of a vehicle key,

FIG. 2 shows two transceivers successfully measuring a distance from a vehicle key,

FIG. 3 shows four quadrants around a vehicle with one comparison point in each,

FIG. 4 shows four comparison points for a vehicle,

FIG. 5 shows distances of transceivers successfully measuring a distance from a vehicle key, and the distances of said transceivers from comparison points,

FIG. 6 shows quadrants that are most probably accurate as a vehicle key position based on the smallest comparison point distance sums of comparison point distances from transceivers that were able to successfully determine a vehicle key distance from the vehicle key,

FIG. 7 shows determination of the accurate position of a vehicle key using a further transceiver, which is arranged outside the axes of symmetry of the vehicle, if said transceiver successfully measures a vehicle key distance.

### DETAILED DESCRIPTION

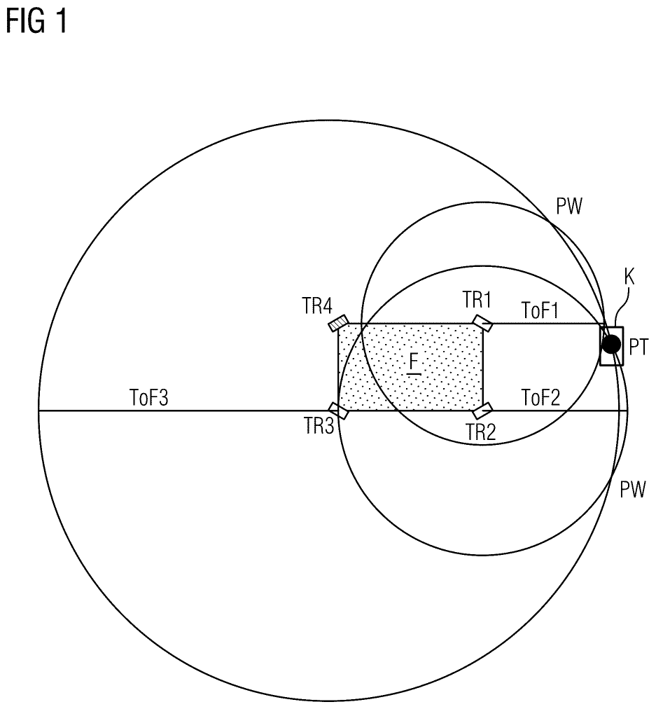

FIG. 1 shows a vehicle F (in particular a motor vehicle, in particular a car or truck) having multiple vehicle transceivers TR1, TR2, TR3, TR4, each of which determines its vehicle key distance ToF1, ToF2, ToF3, ToF4 from a vehicle key K (in particular in order to open and/or start the vehicle) by transmitting and receiving (e.g. UWB) signals to the vehicle key K.

By way of example, the distances can be taken into account by way of one or more propagation time measurements (of signal propagation times from the transceiver to the vehicle key and/or from the vehicle key to the transceiver), that is to say “time of flight” methods, in particular by way of so-called “ranging” in which e.g. two or three or more signal propagation times per transceiver are taken into account in order to determine a distance of the vehicle key from the transceiver.

The signals may be e.g. so-called UWB or ultra-wideband signals.

Multiple measured vehicle key distances ToF1, ToF2, ToF3, ToF4 of each one of the vehicle transceivers TR1, TR2, TR3, TR4 from a vehicle key K can be used to determine a vehicle key position (relative to the vehicle, including to the left/to the right/in front/behind) by way of multilateration, e.g. trilateration, centroid algorithms, Levenberg/Marquardt algorithms, etc.

E.g. the presumed incorrect (PW) or accurate (PT) position PW, PT of a vehicle key K may, as in FIG. 1, be located on a circle having the radius of a vehicle key distance ToF1 around a transceiver TR1 measuring said distance, and additionally on a circle having the radius of a vehicle key distance ToF2 around a further transceiver TR2 measuring said distance, and possibly, in some cases, also additionally on a circle having the radius of a vehicle key distance ToF3 around at least one third, further transceiver TR3 measuring said distance.

Here, each presumed incorrect (PW) or accurate (PT) position of a vehicle key K is situated on a point of intersection between at least two circles.

If only two measurements of a vehicle key distance ToF1 are successful, however, there are two points of intersection between circles, that is to say two possible positions PW, PT of a vehicle key K, e.g. to the left or to the right of the vehicle K, only one being correct and e.g. being supposed to authorize opening of the correct door (to the left or to the right or not at all) of a vehicle K.

When three circles intersect (and vehicle key distances ToF1, ToF2, ToF3 are successfully measured), determining the accurate position PT of a vehicle key K is thus rather easier than when only two circles intersect (and vehicle key distances ToF1, ToF2 are successfully measured).

In FIG. 1, the vehicle transceivers TR1, TR2, TR3 are successful in determining their respective vehicle key distance ToF1, ToF2, ToF3 from a vehicle key K, but the vehicle transceiver TR4 is not.

Vehicle transceivers TR1, TR2, TR3, TR4, (TR5) may e.g. be unsuccessful (without success) in determining their respective vehicle key distance ToF1, ToF2, ToF3 from a vehicle key K due to disturbances such as reflections, damping, shadowing or other problems.

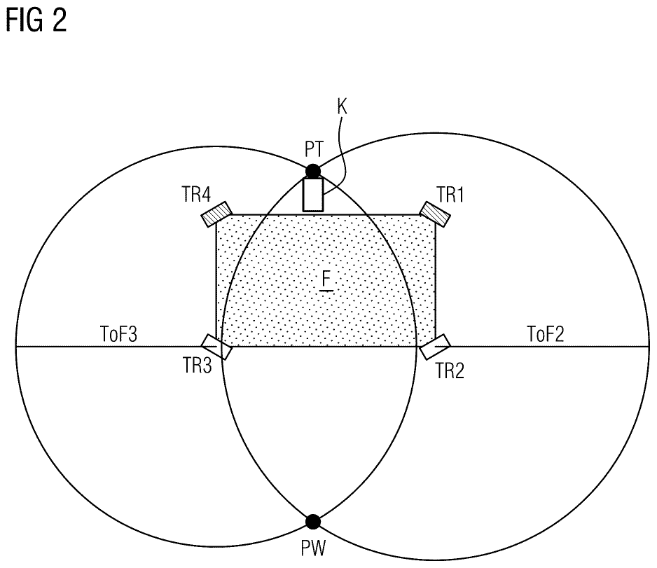

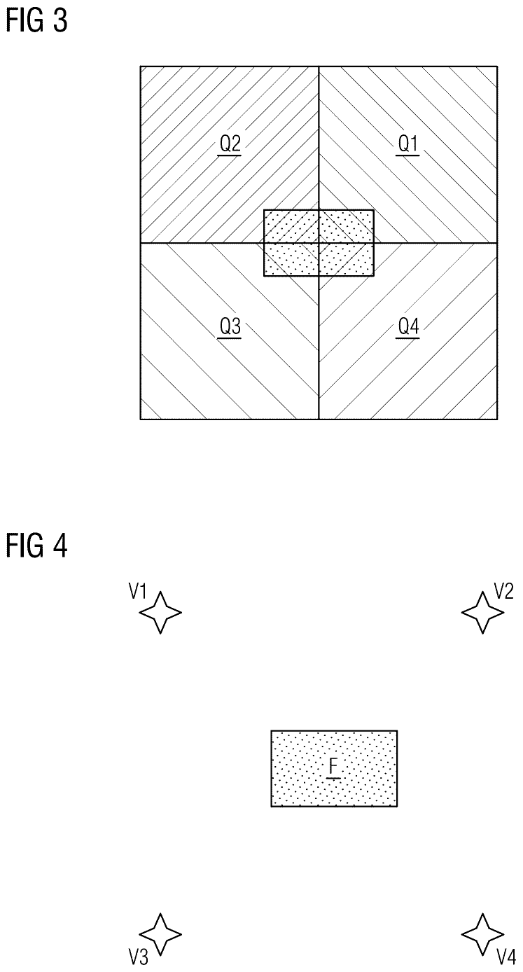

In FIG. 2, only the two vehicle transceivers TR1, TR2 are successful in determining their respective vehicle key distance ToF1, ToF2 from a vehicle key K, but the vehicle transceivers TR3, TR4 are not.

To now still determine the accurate position PT of a vehicle key K, e.g. also whether it is located to the left or to the right and/or in front of or behind the vehicle F, four quadrants Q1, Q2, Q3, Q4, each having one of four comparison points V1, V2, V3, V4 in space (in the plane shown), are used:

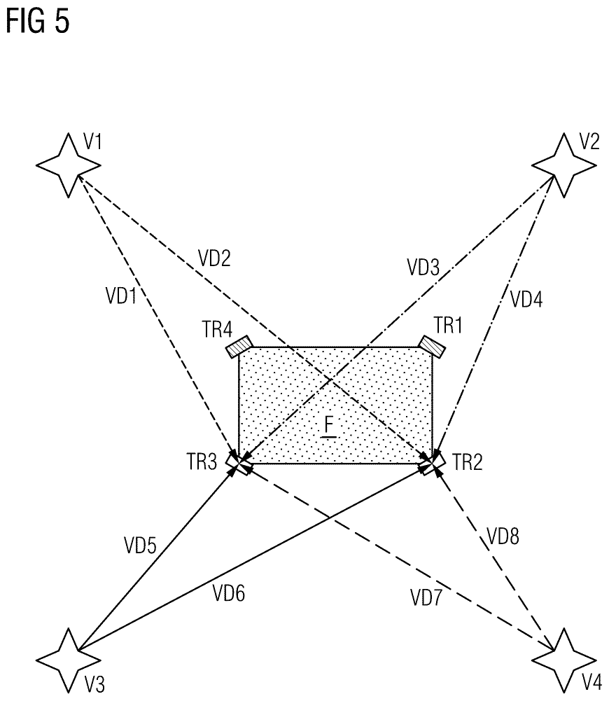

As shown by way of example in FIG. 4, the four comparison points V1, V2, V3, V4 may e.g. be the centers or corners of quadrants Q1, Q2, Q3, Q4 and/or be at the same distance from the spatial vehicle center of the vehicle F.

E.g. the comparison point V1 may be situated in the quadrant Q1, the comparison point V2 may be situated in the quadrant Q2, the comparison point V3 may be situated in the quadrant Q3, and the comparison point V4 may be situated in the quadrant Q4.

As shown by way of example in FIG. 5, for each comparison point V1, V2, V3, V4, the comparison point distances VD1-VD8 of said comparison point from transceivers TR1, TR2 that were able to successfully determine a vehicle key distance ToF1, ToF2 from the vehicle key K can be added as a comparison point distance sum.

Comparison point distances VD1-VD8 (between e.g. all comparison points V1, V2, V3, V4 and all transceivers TR1, TR2, TR3, TR4) may e.g. be stored in an apparatus (computer, controller) of the vehicle F, and may e.g. have been measured by ToF measurement or otherwise once, e.g. during construction of the vehicle.

According to the exemplary embodiment shown in FIG. 5, e.g. two quadrants Q3, Q4 for whose respective comparison point V3, V4 the smallest comparison point distance sums (from transceivers TR2, TR3, which, here, are the only ones to successfully measure vehicle key distances) are determined, can be defined as selected quadrants, wherein that vehicle key position PT, from possible vehicle key positions PT, PW in selected quadrants Q3, Q4 based on vehicle key distances, for which the shortest vehicle key distance ToF1 was identified by a transceiver TR1 (compared with the other transceivers that successfully determine a vehicle key distance) is then assumed to be the actual vehicle key position PT.

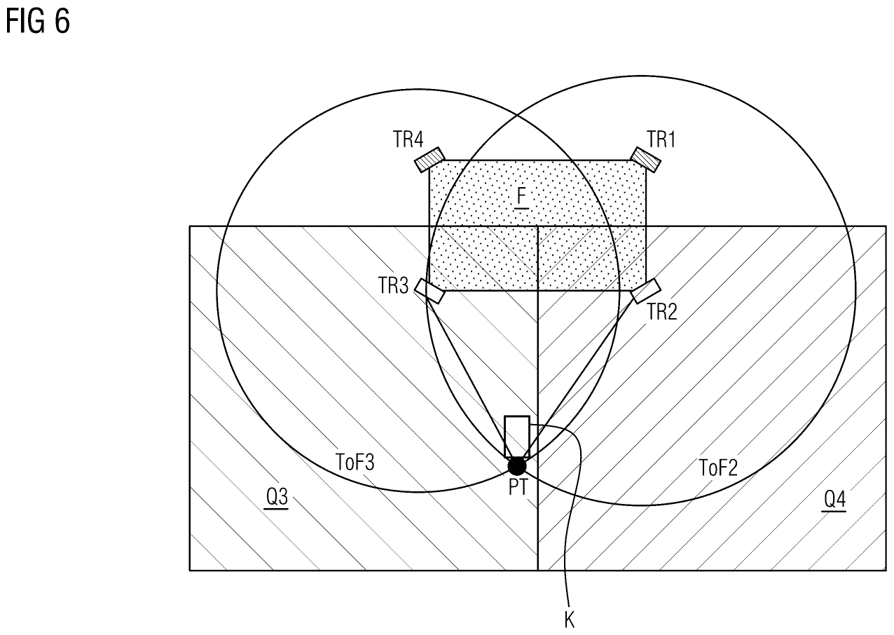

FIG. 6 shows two quadrants Q3, Q4 that are most probably accurate based on the smallest comparison point distance sums of comparison point distances VD1-VD8 from transceivers TR1, TR2 that were able to determine a vehicle key distance ToF1, ToF2 from the vehicle key K.

It is thus assumed that the accurate position PT of the vehicle key K is located in these quadrants Q3, Q4, that is to say, based on the measured vehicle key distance ToF1, ToF2, at the point PT, that is to say to the right of the vehicle, that is to say that the vehicle door on the right is supposed to be opened, but not the vehicle door on the left.

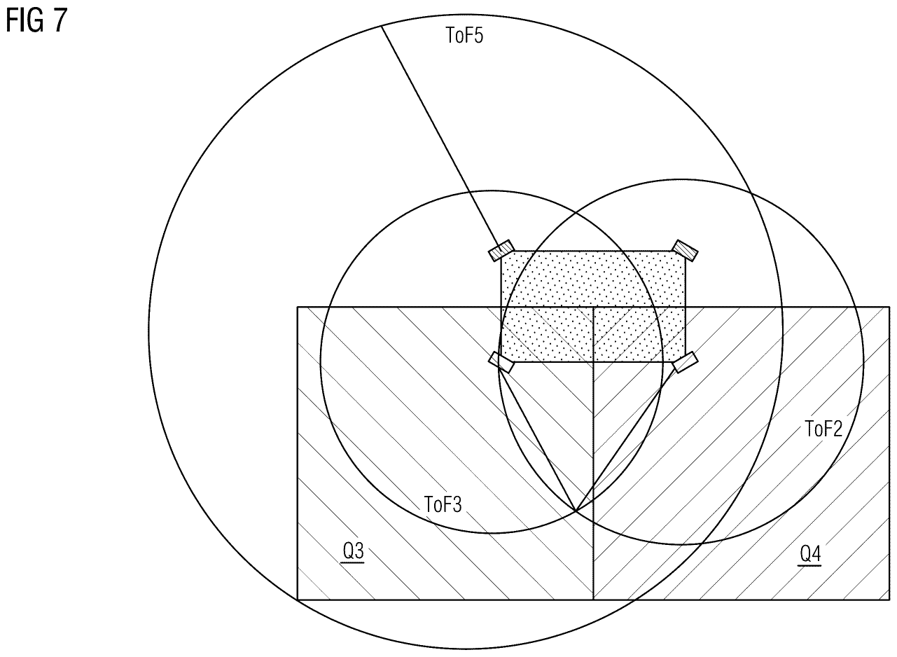

FIG. 7 shows another solution, in which a further transceiver TR5 is used, which is located outside the longitudinal axis of the vehicle F, that is to say here a little to the side and preferably behind, and whose measurement of a vehicle key distance ToF5 can be used to determine the accurate position PT of the vehicle key K if the further transceiver TR5 is successful in measuring a vehicle key distance ToF5 (that is to say despite radio interference problems, etc).

By contrast, a respective pair of two transceivers TR1, TR2; TR3, TR4 is arranged symmetrically with respect to the longitudinal central axis of the vehicle F in FIG. 7. A respective pair of two transceivers TR2, TR3 is arranged symmetrically with respect to the transverse central axis of the vehicle, which can result in the aforementioned problems and solutions according to configurations of the disclosure.

1-11. (canceled)

12. An apparatus for determining a position of a vehicle key relative to a vehicle, wherein the vehicle includes multiple transceivers for determining a vehicle key distance between each transceiver and the vehicle key, wherein multiple comparison points are defined in space, wherein the apparatus is designed to the effect that,
for each comparison point, the comparison point distances of said comparison point from transceivers that were able to determine a vehicle key distance from the vehicle key are added as a comparison point distance sum,
wherein two quadrants for whose respective comparison point the smallest comparison point distance sums were determined are defined as selected quadrants, and
wherein the vehicle key position, from possible vehicle key positions in selected quadrants based on vehicle key distance, for which the shortest vehicle key distance was identified by a transceiver is assumed to be the actual vehicle key position.

13. The apparatus as claimed in claim 1, wherein there is provision for determination of the vehicle key distances from transceivers in each case by way of a ranging measurement and/or on a UWB basis.

14. The apparatus as claimed in claim 1, further comprising at least one of a low pass filter and a Kalman filter for determining the most probable vehicle key distance based on the presumed speed of the vehicle key relative to the vehicle.

15. The apparatus as claimed in claim 1, wherein vehicle key distances are determined for authorization checking when an attempt is made to open a door of the vehicle.

16. The apparatus as claimed in claim 1, wherein vehicle key distances are measured repeatedly.

17. The apparatus as claimed in claim 1, wherein there is provision for a weighting decision for multiple that successfully determines a vehicle key distance in order to select the actual vehicle key position from multiple possible accurate and inaccurate vehicle key positions.

18. The apparatus as claimed in claim 1, wherein for each comparison point, the comparison point distances of said comparison point from transceivers that were able to determine a vehicle key distance from the vehicle key are determined, and are added as a comparison point distance sum.

19. The apparatus as claimed in claim 1, wherein four comparison points are defined in space, which all form the centers or all form the corners of quadrants at the same distance from the spatial vehicle center of the vehicle.

20. The apparatus as claimed in claim 1, wherein the actual vehicle key position is used to determine the side of the vehicle on which the vehicle key is located in order to take this as a basis for permitting a side or rear vehicle door of the vehicle to be opened.

21. The apparatus as claimed in claim 1, wherein at least one respective pair of two transceivers is arranged symmetrically with respect to a longitudinal central axis of the vehicle and/or at least one pair of two transceivers is arranged symmetrically with respect to the transverse central axis of the vehicle.

22. A method for determining a position of a vehicle key relative to a vehicle,
wherein multiple transceivers are used on the vehicle for determining a respective vehicle key distance between the respective transceiver and the vehicle key,
wherein multiple comparison points are defined in space,
wherein, for each comparison point, the comparison point distances of said comparison point from transceivers that were able to determine a vehicle key distance from the vehicle key are added as a comparison point distance sum,
wherein two quadrants for whose respective comparison point the smallest comparison point distance sums were determined are defined as selected quadrants, and
wherein the vehicle key position, from possible vehicle key positions in selected quadrants based on vehicle key distances, for which the shortest vehicle key distance was identified by a transceiver is assumed to be the actual vehicle key position.
